(19) United States
(12) Patent Application Publication
(10) Pub. No.: US 2023/0148821 A1
(43) Pub. Date: May 18, 2023

(54) HAND-HELD FLOOR CLEANING MACHINE

(71) Applicant: Hako GmbH, Bad Oldesloe (DE)

(72) Inventors: Carsten PROTZ, Altenkrempe (DE); Bertram ULRICH, Lübeck (DE); Max MACKERODT, Lübeck (DE)

(21) Appl. No.: 17/987,178

(22) Filed: Nov. 15, 2022

(30) Foreign Application Priority Data
Nov. 16, 2021 (DE) 102021129923.3

(51) Int. Cl. A47L 11/40; A47L 11/283; F16C 11/06

(52) U.S. Cl. CPC A47L 11/4075; A47L 11/283; A47L 11/4038; A47L 11/4061; F16C 11/0628

(57) ABSTRACT

A floor cleaning machine with a base, a control handle and a joint that permits that permits the handle to be pivoted in arbitrary directions relative to the base. The joint has first and second joint elements that are each attached to a corresponding of the base and the control handle. The first joint element has an envelope in the shape of a ball socket and is received into the second joint element. The first joint element is pivotable relative to the second joint element about a stationary fulcrum. The center of the envelope is non-displaceable relative to the second joint element. Grooves, which run in an arcuate manner, are provided on one of the first and the second joint elements, while corresponding engagement parts are provided on the other one of the first and the second joint elements and extend into corresponding ones of the grooves.

### CROSS-REFERENCE TO RELATED APPLICATIONS

This application claims the benefit of German Patent Application No. 10 2021 129 923.3 filed Nov. 16, 2021, the disclosure of which is incorporated by reference as if fully set forth in detail herein.

### FIELD

The present disclosure relates to a hand-held floor cleaning machine, in particular a scrubbing-drying machine, having a base and a control handle, wherein the base has a cleaning element assembly having at least one driven cleaning element, and wherein the control handle extends along a longitudinal axis between a proximal end and an activation end, and by way of a joint is pivotably attached to the base such that the control handle can be pivoted in arbitrary directions in relation to the base.

### BACKGROUND

Floor cleaning machines of this type are known from the prior art. For example, Ep 2 962 614 B1 describes a floor cleaning machine which has a base on which is provided a cleaning element assembly having two rotatingly driven cleaning elements. A control handle is pivotably attached to the base, wherein said control handle can be pivoted in relation to the base about two mutually separate pivot axes that run so as to be mutually perpendicular. The joint assembly here is designed in such a manner that, by pivoting the control handle about the longitudinal axis thereof, the base can be rotated about a vertical axis that extends perpendicularly to the floor area to be cleaned. By means of the control handle it is thus possible for a torque about the vertical axis to be exerted on the base in order for the latter to be controlled, thus for the alignment of said base on the floor area to be cleaned to be varied.

However, the floor cleaning machine known from the prior art has proven disadvantageous because the construction of the joint assembly is complicated and occupies a comparatively large amount of space.

It is therefore one object of the present disclosure to provide a floor cleaning machine described at the outset, which has a control handle and a base, and in which the joint disposed between the control handle and the base is of a simple and compact construction.

### SUMMARY

This section provides a general summary of the disclosure, and is not a comprehensive disclosure of its full scope or all of its features.

In one form, the present disclosure provides a floor cleaning machine having a base and a control handle. The base has a cleaning element assembly with at least one driven cleaning element on which at least one engagement element is provided. The cleaning element, by way of the at least one engagement element provided thereon, is configured to engage with a floor area to be cleaned. The control handle can extend along a longitudinal axis between a proximal end and an activation end, and by way of a joint is attached to the base so as to be pivotable in such a manner that the control handle can be pivoted in arbitrary directions in relation to the base. The joint has a first joint element, the envelope thereof being in the shape of a ball socket, and a second joint element, wherein the first joint element is received in the second joint element and is supported in the latter in such a manner that the first joint element in relation to the second joint element is pivotable about a fulcrum which is stationary in terms of the second joint element and coincides with the center of the envelope, and that the center of the envelope is non-displaceable relative to the second joint element.

In some forms, on one of the first and the second joint element are at least two grooves that run in an arcuate manner, are open toward the envelope and extend along the envelope; and provided on the other of the first and the second joint element are at least one first engagement part and one second engagement part, wherein the first engagement part extends into the first one of the grooves, and the second engagement part extends into the second one of the grooves. Finally, the first joint element is attached to one of the base and the proximal end of the control handle, and the second joint element is attached to the other one of the base and the proximal end of the control handle.

In some forms the floor cleaning machine has a base and a control handle. A cleaning element assembly can be provided on the base and can include at least one driven cleaning element that has at least one engagement element of which the free end can engage with the floor area to be cleaned. For example, the cleaning element can be a brush and the engagement elements can be bristles, the free ends thereof engaging with the floor area to be cleaned. However, it is likewise conceivable that the cleaning element is a so-called pad in which the engagement element is formed by a planar material provided on the pad, the surface of said planar material coming to bear on the floor area to be cleaned. However, the present invention is not limited to these two examples, but arbitrary other forms of cleaning elements may also be used. The cleaning elements here can be driven in a rotating or else linear manner, or said cleaning elements can perform an orbital movement. Here too, the present disclosure is not limited to these drive options, but the cleaning elements can also be driven in any other arbitrary manner.

In some forms, the control handle can extend along a longitudinal axis away from the base and can have a proximal end and an activation end. The proximal end can be disposed so as to be adjacent to the base, while the activation element is provided on the end of the control handle that is distal from the base, The activation element can include handles or the like such that the activation end can be held by a user.

In some forms, between the proximal end of the control handle and the base is a joint which initially is configured in such a manner that the control handle can be pivoted in arbitrary directions in relation to the base. The joint can have a first joint element, of which the envelope is in the shape of a ball socket. Owing to the fact that the envelope of the first joint element is in the shape of a ball socket, this also includes the possibility that the first joint element per se may be in the shape of a ball. However, it is also possible for the first joint element to have a multiplicity of planar elements, the external edges of the latter being configured so as to be arcuate. It is thus not mandatory for the first joint element to be configured in the shape of a ball, but it suffices for the first joint element to be of such a design that an envelope has the shape of a ball.

In some forms, a second joint element which receives the first joint element and supports the latter in such a manner that the first joint element in relation to the second joint element can be pivoted about a fulcrum which is stationary relative to the second joint element. The fulcrum can coincide with the center of the envelope, which is in the shape of a ball socket, of the first joint element. Accordingly, the first joint element can be guided in the second joint element in such a manner, i.e. parts of the second joint element suitably bear on the first joint element, that the first joint element can be pivoted in relation to the second joint element, in which the fulcrum, through which the respective pivot axis runs, coincides with the center of the envelope. In some examples, the first joint element is mounted in the second joint element such that the center of the envelope cannot be displaced in relation to the second joint element. Such a configuration renders possible only the pivoting movement, while a displacing movement of the first joint element relative the second element is prevented.

In some forms, on one of the first and the second joint elements there are provided at least two grooves that run in an arcuate manner, are open toward the envelope and extend along the envelope. When the grooves are provided on the first joint element having the envelope that runs in the shape of a ball socket, the grooves extend inward from the envelope and run along an arcuate line along the envelope. Alternatively, when the grooves are provided on the second joint element, said grooves are configured on an internal face of the second joint element and open toward the first joint element. Said grooves here likewise extend along an arcuate line and about the envelope of the first joint element. Provided on the other one of the first and the second joint element can be at least one first engagement part and one second engagement part, wherein the first engagement part extends into the first one of the grooves, and the second engagement part extends into the second one of the grooves. In such a configuration, the engagement parts that engage with the grooves are provided either on the internal face of the second joint element or on the external face of the first joint element.

It is achieved as a result of the engagement between the engagement parts and the grooves that, in a pivoting movement of the control handle about the longitudinal axis thereof, a torque is transmitted to the base. This transmission of torque can be independent of how the control handle is pivoted in relation to the base. This can be achieved if ultimately either the first or the second joint element is fastened to the base, while the second or the first joint element is attached to the proximal end of the control handle.

In some forms, the joint formed from the first and the second joint element is of a compact construction because the first joint element is received in the second joint element, and it is moreover made possible for a torque to be transmitted from the first to the second joint element and thus from the control handle to the base.

In some forms, the grooves in terms of the center of the envelope are disposed so as to be diametrically opposite on one of the first and the second joint element. Accordingly, the first and the second groove run in a plane that runs through the center of the envelope. In this way, even comparatively high torques can be reliably transmitted from the control handle to the base.

In some forms, the first and the second engagement parts can be disposed so as to be diametrically opposite in a central plane that runs through the center of the envelope and perpendicularly to the longitudinal axis of the control handle. In this arrangement, the engagement between the engagement parts and the grooves takes place at the largest possible spacing from the longitudinal axis of the control handle from which the torque is to be transmitted to the first joint. The stress on the engagement parts and the grooves is minimized as a result of this large spacing.

Optionally, the grooves to extend about the envelope by more than 150° so that the control handle can be pivoted in relation to the base by way of a circumference that is as large as possible.

In some forms, the second joint element has a circular receptacle opening having a diameter that is smaller than the diameter of the envelope. It is ensured as a result that the first joint element cannot slip out of the second joint element but is guided in the latter in the manner already described.

Optionally, the first and/or the second engagement part are/is configured as a ball which are/is mounted so as to be stationary and rotatable on the other one of the first and the second joint element, and able to roll in one of the grooves. In this way, the friction between the first and the second joint element can be reduced and preferably minimized when the control handle is pivoted relative to the base, as well as during a pivoting movement of the control handle about the longitudinal axis thereof.

In some forms, the grooves that run in an arcuate manner are provided on the first joint element, while the second joint element on the internal wall thereof has the first engagement part and the second engagement part. The first joint element can be attached to the base by way of the envelope in the shape of a ball socket, and the second joint element to be fastened to the proximal end of the control handle.

Optionally, the first joint element to be attached to the base, and the second joint element to be attached to the proximal end of the control handle.

In some forms, the joint has a locking assembly which is designed such that said locking assembly can be moved to a releasing position and a locking position. Optionally, a pivoting movement of the second joint element about the first joint element is possible in the releasing position, and a pivoting movement of the second joint element about the first joint element is impossible in the locking position. It is thus possible for the control handle to be locked in a pre-defined position relative to the base, which can facilitate the parking of the floor cleaning machine with the control handle remaining in a pre-defined position.

Optionally, one of the first and the second joint elements has a receptacle clearance of which the opening extends toward the envelope. In some forms, provided on the other one of the first and the second joint element is a latch element which, in a direction that runs perpendicularly to the envelope, is displaceable in relation to the other one of the first and the second joint element such that said latch element in the releasing position does not extend beyond the envelope toward the one of the first and the second joint element, and said latch element in the locking position extends beyond the envelope toward the one of the first and the second joint element, and into the receptacle clearance. The pivoted position in which the control handle can be locked relative to the base is established by the position of the receptacle clearance in the one of the first and the second joint elements.

It may be desirable in some situations that the displaceable latch element be provided on the second joint element and be displaceable along the longitudinal axis along which the control handle extends, relative to the latter. The receptacle clearance in this instance is provided in the first joint element, the envelope of the latter being in the shape of a ball socket. In this instance, the activation mechanism for the locking assembly can be of a comparatively simple design, such as an activation rod or a Bowden cable that is routed along the longitudinal axis of the control handle, toward the activation end of the latter.

In some forms, the at least one engagement part of the at least one cleaning element has a free end. The at least one free end defines a cleaning plane in which the at least one engagement part engages with the floor area. The control handle can be pivotable relative to the base to a vertical position in which the longitudinal axis of the control handle extends upward away from the cleaning plane, for example so as to be perpendicular to the latter. The control handle in the locking position can be in the vertical position. In such a configuration, the control handle can be locked relative to the base such that the control handle extends in a substantially vertical direction. This may be desirable, for example, when the floor cleaning machine is not in operation is to be transported or parked.

Optionally, the floor cleaning machine can be provided with a pre-loading element which, in a position in which the control handle is pivoted from the vertical position counter to the main operating direction, is designed to impinge said control handle with a force toward the vertical position. When the control handle is thus pivoted from the vertical position in a direction that is counter to the main operating direction, the pre-loading element causes the control handle to be impinged with a force that pushes said control handle back in the direction of the vertical position. As a result, the force which a user has to apply in order for the control handle to be held in an inclined position during the normal operation is reduced. This is because the user, in the absence of the pre-loading element, would have to absorb the entire torque caused by the weight of the control handle in order to prevent the control handle from pivoting further downward toward the floor area to be cleaned. The pre-loading element can be configured as a compression spring which is compressed when the control handle is pivoted counter to the main operating direction. Alternatively, it is also conceivable for the pre-loading element to be configured as an elastic traction element which is tensioned when the control handle is pivoted from the vertical position counter to the main operating direction.

Optionally, the pre-loading element is configured as a spring element that is fastened to a first end on the control handle, the second end of said spring element being connected to a strap element, and the strap element on the side of the joint that points in the main operating direction is guided from the control handle to the base, and is fastened to the base. When the control handle of such a configuration is pivoted rearward, counter to the main operating direction, the spacing between the point of articulation of the strap element on the base and the point where the strap element is attached to the spring element is increased. This in turn leads to the spring element being extended, this conversely generating a force that presses the control handle back to the vertical position. In this way, the torque which has to be applied by a user for preventing the control handle from pivoting completely downward toward the floor area is reduced.

Optionally, the strap element to be fastened to the base so as to be spaced apart from the joint, and by way of a guide to be guided in a displaceable manner on the base, so as to be spaced apart from the fastening point. This makes it possible for a user to grip the portion of the strap element between the fastening point and the guide, and as a result for a gripping portion to be formed, the latter making it possible for the base to be easily lifted.

It is to be pointed out here that the concept of a strap element of which one end is fixed to the base, which, on a side that points in the main operating direction, is guided about the joint between the base and the control handle to the control handle, and which is fastened to the free end of a spring element, the other end of which is articulated on the control handle, represents an independent inventive concept. The latter can generally be used in floor cleaning machines having a base and a control handle, wherein the control handle is attached to the base by way of a joint. This concept is not limited to the use with the articulated constructions described above.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a first perspective lateral view of an exemplary embodiment of a floor cleaning machine according to the present disclosure;

FIG. 2 is a second perspective lateral view of the exemplary embodiment from FIG. 1;

FIG. 3 is a partial lateral view of the joint of the exemplary embodiment from FIG. 1;

FIG. 4 is a first sectional view of the joint of the exemplary embodiment from FIG. 1;

FIG. 5 is a second sectional view of the joint of the exemplary embodiment from FIG. 2;

FIGS. 6A and 6B are lateral views of the joint of the exemplary embodiment from FIG. 1 in different pivoted positions;

FIGS. 7A and 7B are lateral views of the joint of the exemplary embodiment from FIG. 1 in a first design embodiment in different pivoted positions;

FIGS. 8A and 8B are lateral views of the joint of the exemplary embodiment from FIG. 1 in a second design embodiment in different pivoted positions; and

FIGS. 9A and 9B are a lateral view and a perspective view, respectively, of the exemplary embodiment from FIG. 1 in a third design embodiment.

Corresponding reference numerals indicate corresponding parts throughout the several views of the drawings.

### DETAILED DESCRIPTION

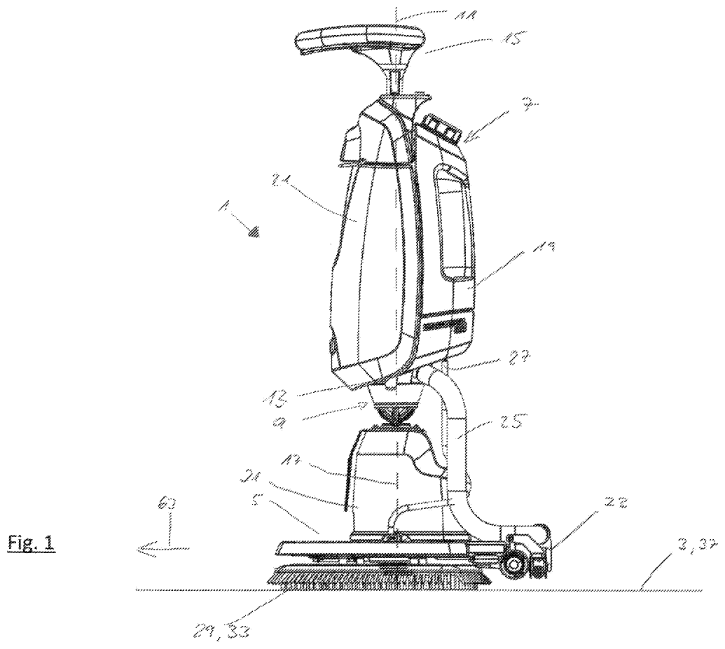

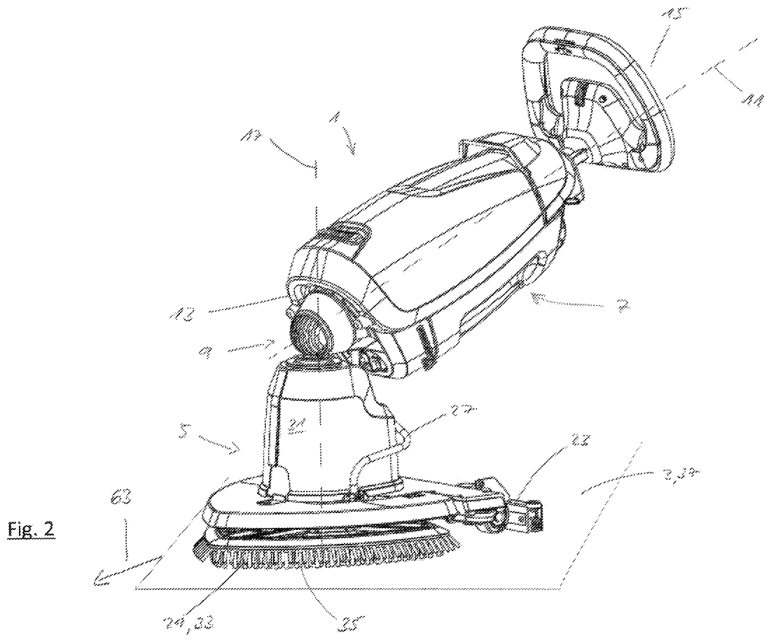

Illustrated in FIGS. 1 and 2 is an exemplary embodiment of a floor cleaning machine 1 according to the present invention, said floor cleaning machine 1 here forming a hand-held scrubbing-drying machine and being provided with a cleaning element assembly by way of which cleaning liquid can be applied to the floor area 3 (see FIGS. 1 and 2), and having cleaning elements for engaging with the floor area 3 to be cleaned. The scrubbing-drying machine is furthermore provided with a suction foot by way of which scrubbed residue, including the cleaning liquid, can be suctioned off again. The exemplary embodiment of a floor cleaning machine 1 described here has a control handle 7, which is yet to be described in detail hereunder and is attached to a base 5 of the floor cleaning machine 1, wherein the control handle 7 by way of a joint 9 is pivotably attached to the base 5.

The exemplary embodiment of a floor cleaning machine 1 according to the invention described here, as has already been mentioned, comprises the base 5 to which the control handle 7 is attached by way of a joint 9, the latter being described in yet more detail hereunder. The control handle 7 extends here from the joint 9, by way of which said control handle 7 is pivotably connected to the base 5, along a longitudinal axis 11 from a proximal end 13 to an activation and 15, wherein the proximal end 13 of the control handle 7 is provided so as to be adjacent to the joint 9 and is connected to the latter. The joint 9 here is designed in such a manner that, when the control handle 7 is pivoted or rotated about the longitudinal axis 11, a torque is exerted on the base 5 such that the latter is pivoted about a vertical axis 17 in relation to the floor area 3, wherein the vertical axis 17 runs perpendicularly to the floor area 3. The joint 9, by virtue of the construction thereof, thus makes it possible for a user who grips the control handle 7 on the activation and 15 of the latter to be able to steer the base 5. The exact design embodiment of the joint will be described hereunder.

A cleaning liquid container 19 and a wastewater tank 21 are releasably attached to the control handle 7, said cleaning liquid container 19 and said wastewater tank 21 by way of lines 25, 27 being connected to the base 5 as well as to a suction foot 23, the latter being pivotably mounted on the base 5. The suction foot 23 here can be pivoted between the position shown in the figures, in which said suction foot 23 lies opposite the floor area 3 to be cleaned, and a folded-up position in which said suction foot 23 is spaced apart from the floor area 3.

Finally provided on the lower side of the base 5 that points toward the floor area 3 to be cleaned is a cleaning element assembly 29 (see FIGS. 1 and 2) which is designed to engage with the floor area 3 to be cleaned, wherein the cleaning element assembly 29 is driven by a drive motor (not illustrated) disposed in a housing 31 on the base 5. The drive motor can be, for example, an electric motor which is supplied by a battery unit which is not illustrated and is attached to the base 5 or to the control handle 7. However, the present invention is not limited to electric motors and it is in principle also possible for the drive motor to be driven by compressed air. This may be the case when the floor cleaning machine is used as an auxiliary apparatus on a self-driving machine.

Furthermore disposed in the housing 31 of the base 5 is a suction turbine (not illustrated), the suction side of which is connected to the upper end of the wastewater tank 21. The wastewater tank 21 in turn is connected to the suction foot 23 by way of the line 25. The suction turbine forms a suction installation with the aid of which a suction airflow from the suction foot 23 into the wastewater tank 21 is generated, such that cleaning liquid can be suctioned off from the floor area 3 to be cleaned. Furthermore provided on the base 5 are additional lines 27 by way of which the cleaning liquid from the cleaning liquid container 19 by way of the base 5 can be conveyed into the region of the cleaning element assembly 29 and in the process be applied to the floor area 3 to be cleaned.

The cleaning element assembly 29 in the preferred exemplary embodiment shown here has two driven cleaning elements 33 which in a manner not illustrated are attached such that an external cleaning element surrounds an internal cleaning element and the cleaning elements 33 are driven in such a manner that said cleaning elements perform orbital movements which are mutually out of phase by 180°. It is achieved by this type of drive that the cleaning elements when they are moved, do not conjointly generate any propulsion acting on the base 5 relative to the floor area 3 to be cleaned. The cleaning elements 33 in the present exemplary embodiment are designed as brush elements so that engagement elements in the form of bristles 35 extend in each case away from a main body, wherein the free ends of the bristles 35 engage with the floor area 3 to be cleaned, and the free ends thus define a cleaning plane 37 which coincides with the plane of the floor area 3. In this way, the vertical axis 17 also extends perpendicularly to the cleaning plane 37.

In the exemplary embodiment described here, the engagement elements are configured as bristles 35, and the cleaning elements are provided as brushes. However, it is also conceivable for other types of cleaning elements to be used. For example, pads which are driven can be used, the faces of the pads that extend toward the floor area 3 to be cleaned, or extend in the cleaning plane 37, respectively, forming the engagement elements. The present invention is in particular not limited to the use of brushes.

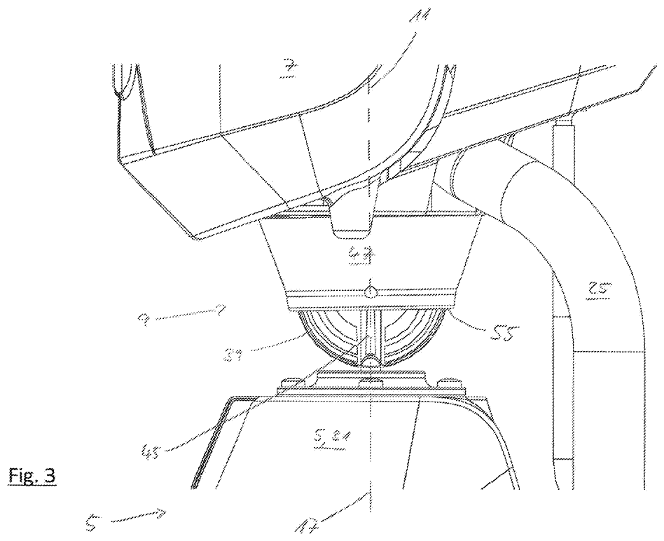

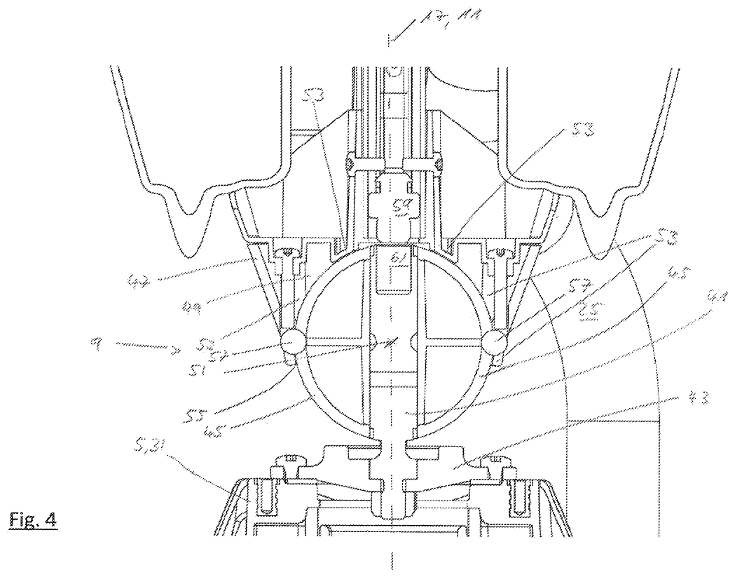

The construction of the joint 9, by way of which the base 5 and the control handle 7 are pivotably coupled to one another, will now be described hereunder, wherein the construction of the joint 9 provided here is very compact, on the one hand, and makes possible the transmission of a torque from the control handle 7 to the base 5 already described, on the other hand, such that the latter can pivot about the vertical axis 17. It can be derived from FIGS. 3 and 4 here that a first joint element 39 is fastened to the upper end of the housing 31 that points toward the control handle 7, wherein this first joint element 39 is configured in such a manner that an envelope enclosing the first joint element 39 is configured in the shape of a ball socket. This means that the first joint element 39 per se can be in the shape of a ball. However, this also includes the circumstance that the first joint element 39 is formed from a multiplicity of disks that are disposed so as to be mutually parallel, the outer edges thereof running in an arcuate manner by way of dissimilar diameters such that the envelope overall is in the shape of a ball socket, for example.

The first joint element 39 in the exemplary embodiment described here has an appendage 41 which extends in parallel along the vertical axis 17 and is received by a holder 43 fastened to the housing 31.

It can furthermore be derived in particular from FIG. 3 that the first joint element 39 has grooves 45 that run in an arcuate manner, are open toward the envelope and, in the exemplary embodiment described here, relative to the center of the first joint element 39 and the envelope thereof are disposed so as to be diametrically opposite and run along the envelope. Furthermore, each of the grooves 45 in terms of the center of the envelope of the first joint element 39 runs across more than 150°, in the present case even across 180°.

The joint 9 furthermore has a second joint element 47 which is attached to the proximal end 13 of the control handle and delimits a cavity 49 in which the first joint element 39 is received. The cavity 49 here is configured in such a manner that the first joint element 39 is supported in said cavity 49 in such a manner that said first joint element 39 can be pivoted about a fulcrum 51 which is stationary in terms of the second joint element 47, wherein the fulcrum 51 coincides with the center of the envelope of the first joint element 39. Moreover, the support of the first joint element 39 within the second joint element 47 is of such a type that the first joint element 39, and in particular the center thereof, cannot be displaced in relation to the second joint element 47. The first joint element 39 is thus received so as to be non-displaceable in the second joint element 47. To this end, it is not mandatory that the surface of the second joint element 47, which points inward and delimits the cavity 49, is configured in the shape of a ball socket. Rather, it is sufficient for adequately large support elements 53 to be provided in the interior of the second joint element 47, said support elements 53 guaranteeing the pivoting movement about the fulcrum 51, on the one hand, and ensuring that the first joint element 39 is received in a non-displaceable manner, on the other hand. To this end, it is also provided that the second joint element 47 has a circular receptacle opening 55, the diameter of the latter being smaller than the diameter of the envelope of the first joint element 39. It is already prevented as a result that the first joint element 39 can move out of the cavity 49.

Furthermore provided on the second joint element 47, on the surface that points inward toward the cavity 49, are engagement parts in the form of rotatably mounted balls 57 which extend into the grooves 45 in the first joint element 39. The balls 57 are thus mounted so as to be stationary in the second joint element 47, and are able to roll in the grooves 45. Moreover, the balls 57 in this exemplary embodiment are disposed in a central plane which runs through the center of the envelope, or the fulcrum 51, respectively, and perpendicularly to the longitudinal axis 11 of the control handle 7. Moreover, said balls 57, like the grooves 45, are attached so as to be diametrically opposite relative to the fulcrum 51, or the center of the envelope, respectively.

However, deviating from the above other arrangements of the balls 57 in the second joint element 47 are also conceivable. Moreover, it is also possible for the engagement parts, or the balls 57, respectively, to be mounted on the first joint element 39, while the grooves 45 are provided in the face of the second joint element 47 that points inward.

As a result of the engagement between the engagement parts in the form of the balls 57 and the grooves 45 it is ensured that a torque is transmitted from the control handle 7 to the base 5, even when the longitudinal axis 11 of the control handle 7 is pivoted in relation to the vertical axis 17 during a pivoting movement of the control handle 7 about the longitudinal axis 11, wherein the transmitted torque causes a pivoting movement of the base 5 about the vertical axis 17. As a result of the balls 57 being rotatably mounted in the second joint element 47 and being able to roll in the grooves 45, the friction arising in such a pivoting movement of the control handle 7 about the longitudinal axis 11 of the latter is comparatively minor. In this way, the base 5 can be easily controlled by a user engaging on the activation end 15.

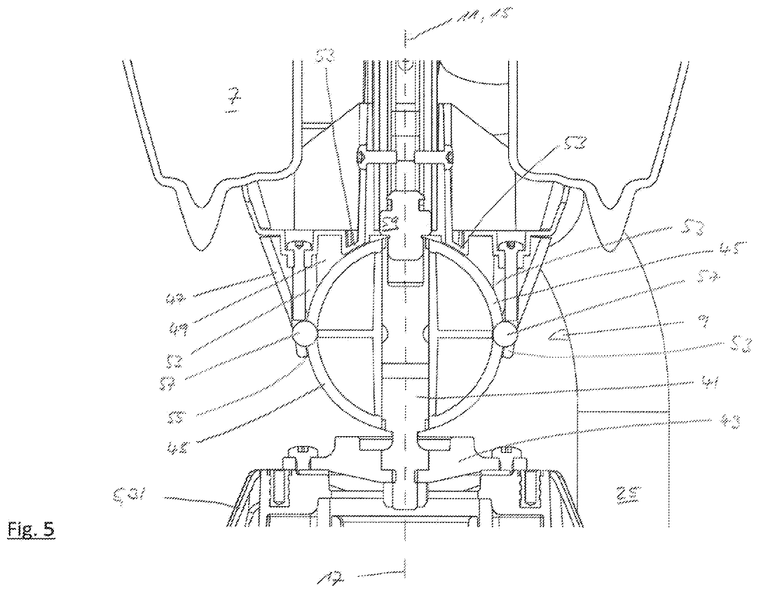

As can be finally derived from FIGS. 4 and 5, the joint 9 has a locking assembly by way of which the control handle 7 can be locked in a defined position relative to the base 5 when the locking assembly is in the locking position. In the preferred exemplary embodiment described here, the position in which the control handle 7 can be locked is chosen in such a manner that the control handle 7 in this instance, by way of the longitudinal axis 11 thereof, extends in such a manner that the longitudinal axis 11 runs parallel to an axis that is perpendicular to the cleaning plane 37, or the floor area 3, respectively. In the locked position of the control handle 7, the longitudinal axis 11 of the latter thus also extends parallel to the vertical axis 17 and is thus in a vertical position. When the locking assembly is in the releasing position, the control handle 7 can be pivoted relative to the base 5 without impediment.

In the exemplary embodiment described here, the locking assembly has a latch element 59 which is mounted on the second joint element 47 in such a manner that said latch element 59, between a releasing position (see FIG. 4) and a locking position (see FIG. 5), is displaceable along the longitudinal axis 11 of the control handle 7, and thus perpendicularly to the envelope of the first joint element 39, wherein this displacement can be caused by an activation element which is provided on the activation panel 15 of the control handle 7 (not illustrated). To this end, the activation element can be coupled to the latch element 59 by way of an activation rod or a Bowden cable (not illustrated).

When the control handle 7 is in the vertical position, as is shown in FIGS. 4 and 5, in which the longitudinal axis 11 of the control handle 7 extends parallel to the vertical axis 17, or to an axis extending perpendicularly to the cleaning plane 37, respectively, the latch element 59 lies opposite a receptacle clearance 61 in the first joint element 39 when the latch element 59 is in the releasing position. However, when the latch element 59 is transferred to a locking position, said latch element 59 can extend into the receptacle clearance 61, which is possible only when the control handle 7 is in the vertical position already described. If the latch element 59 extends into the receptacle clearance 61, the control handle 7 is prevented from performing a pivoting movement from the vertical position.

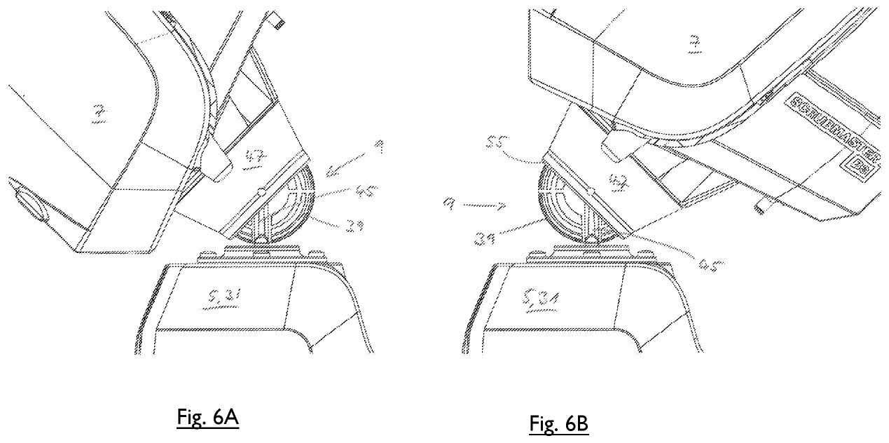

It is derived from FIGS. 6A and 6B that, when the locking assembly is in the releasing position, that is to say the latch element 59 does not extend into the receptacle clearance 61, the control handle 7 can be pivoted in an arbitrary manner in relation to the base 5.

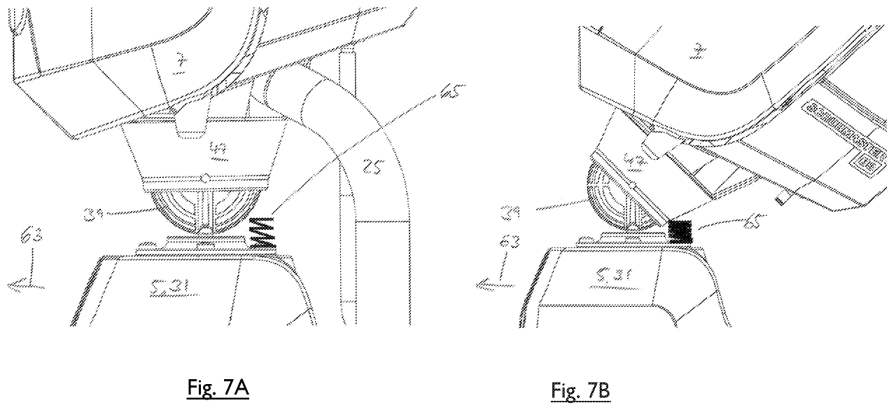

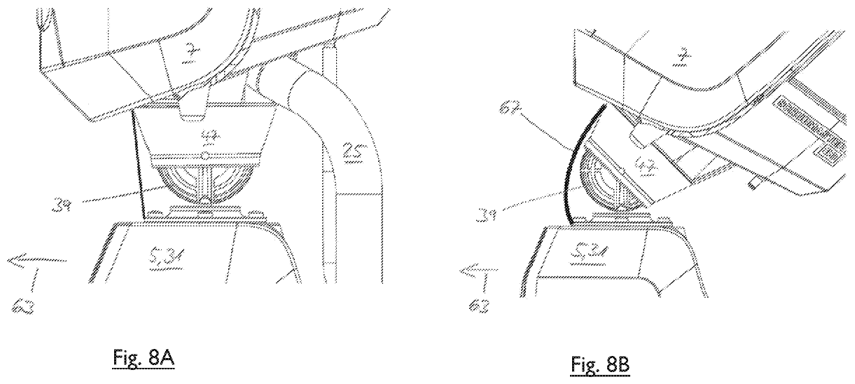

Two further alternatives for enhancing the previously described exemplary embodiment will be explained hereunder with reference to FIGS. 7A through 8B.

A main operating direction of the floor cleaning machine 1 is identified by the arrow 63 in FIGS. 1 and 2. The main operating direction 63 is the direction along which the floor cleaning machine 1 is moved across the floor area 3 to be cleaned in normal operation, so that this direction 63 indicates the straight-ahead direction during operation. It can now be seen in FIGS. 7A and 7B that a compression spring 65 is disposed on the housing 31 of the base 5 on that side of the joint 9, or of the first joint element 39, respectively, that is counter to the main operating direction 63, or faces away from the latter, wherein the compression spring 65 comes to bear on the second joint element 47 when the control handle 7 is pivoted counter to the main operating direction 63 in relation to the base 5. As a result, the compression spring 65 acts as a pre-loading element which in the position illustrated, in which the control handle 7 is pivoted from the vertical position counter to the main operating direction 63, impinges said control handle 7 with a force toward the vertical position. It is achieved in this way that when the control handle 7 is pivoted rearward toward the user, as is shown in FIG. 7B, said user no longer has to sustain the entire weight of the control handle 7 but instead is supported by the compression spring 65.

An alternative embodiment for a pre-loading element which reduces the force that a user has to apply in order to hold the control handle 7 in a position in which the latter is pivoted from the vertical position rearward, counter to the main operating direction 63, is illustrated in FIGS. 8A and 8B. Provided here is an elastic traction element 67 which is elongated when the control handle 7 is pivoted from the vertical position counter to the main operating direction 63, as is shown in FIG. 8B. In this embodiment too, a force is then exerted on the control handle 7 by way of which the latter is drawn toward the vertical position, this in turn reducing the force that has to be applied by a user in order to hold the control handle 7 in the inclined position counter to the effect of gravity.

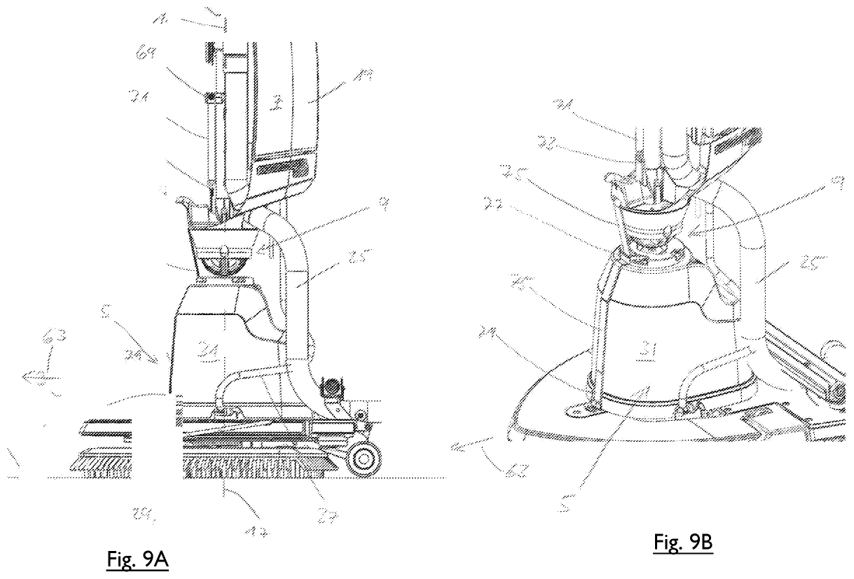

FIGS. 9A and 9B show a further preferred design embodiment of an assembly having a pre-loading element in a lateral view, which is shown in FIG. 9A, and in a perspective illustration that is shown in FIG. 9B.

In this design embodiment, the pre-loading element is configured as a spring element 71, such as a coil spring, which by way of a first end 69 is fastened to the control handle 7, the second end 73 of said spring element 71 being connected to a strap element 75. The strap element 75 along the side of the joint 9 that points in the main operating direction 63 is guided from the control handle 7 to the base 5. The strap element 75 by a guide element 77 here is guided so as to be adjacent to the joint 9, wherein the guide therein is of such a type that the strap element 75 can slide through the guide element 77, thus being displaceable in relation to the guide element 77. Furthermore, the strap element 75 by way of the fastening end 79 is fastened to the base 5 and in this case to the housing 31 of the latter. However, the strap element 75, between the fastening end 79 and the guide element 77, is not fastened to the base 5 or the housing 31 of the latter. It is, therefore, possible to grip the strap element 75 in this portion between the fastening end 79 and the guide element 77, and to pull said strap element 75 away from the housing 31, the spring element 71 being elongated in the process. In this way is a gripping loop is formed by way of which a user can easily lift the base 5 in particular.

When the control handle 7 in this design embodiment is pivoted rearward, counter to the main operating direction 63, the spacing between the point of articulation of the strap element 75 on the base 5, thus the fastening end 79 on the housing 31, and the point where the strap element 75 is attached to the spring element 71, is increased. This in turn leads to the spring element 71 being extended, which conversely generates a force that presses the control handle 7 back to the vertical position. A torque, which has to be applied by a user in order to prevent the control handle 7 from pivoting completely downward toward the floor area 3, is reduced in this way.

It is pointed out here once again that the concept of a strap element of which one end 79 is fixed to the base 5 and which, on a side that points in the main operating direction 63, is guided about the joint 9 between the base 5 and the control handle 7 to the control handle 7 and is fastened to the free (second) end 73 of a spring element 71, the further end 69 of the latter being articulated on the control handle 7, represents an independent inventive concept. The latter can generally be used in floor cleaning machines having a base and a control handle, wherein the control handle is attached to the base by way of a joint. This concept is therefore not limited to the use with the articulated construction described above.

As is derived from the above, the floor cleaning machine 1 according to the invention having the joint 9 is constructed in such a manner that the joint 9 is compact and at the same time makes it possible for a torque about the longitudinal axis 11 of the control handle 7 to be transmitted to the base 5.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

List of reference signs:

| | |
|---|---|
| 1 | Floor cleaning machine |
| 3 | Floor area |
| 5 | Base |
| 7 | Control handle |
| 9 | Joint |
| 11 | Longitudinal axis |
| 13 | Proximal end |
| 15 | Activation end |
| 17 | Vertical axis |
| 19 | Cleaning liquid container |
| 21 | Wastewater tank |
| 23 | Suction foot |
| 25, 27 | Line |
| 29 | Cleaning element assembly |
| 31 | Housing |
| 33 | Cleaning element |
| 35 | Bristles |
| 37 | Cleaning plane |
| 39 | First joint element |
| 41 | Appendage |
| 43 | Holder |
| 45 | Groove |
| 47 | Second joint element |
| 49 | Cavity |
| 51 | Fulcrum |
| 53 | Support element |
| 55 | Receptacle opening |
| 57 | Ball |
| 59 | Latch element |
| 61 | Receptacle clearance |
| 63 | Main operating direction |
| 65 | Compression spring |
| 67 | Traction element |
| 69 | First end |
| 71 | Spring element |
| 73 | Second end |
| 75 | Strap element |
| 77 | Guide element |
| 79 | Fastening end |

What is claimed is:

1. A floor cleaning machine (1) having
a base (5), and
a control handle (7),
wherein the base (5) has a cleaning element assembly (27) having at least one driven cleaning element (33) on which at least one engagement element (35) is provided,
wherein the cleaning element (33, 61), by way of the at least one engagement element (35) provided thereon, is configured to engage with a floor area (3) to be cleaned,
wherein the control handle (7) extends along a longitudinal axis (11) between a proximal end (13) and an activation end (15), and by way of a joint (9) is attached to the base (5) so as to be pivotable in such a manner that the control handle (7) can be pivoted in arbitrary directions in relation to the base (5),
wherein the joint (9) has
a first joint element (39) having an envelope that is in a shape of a ball socket, and
a second joint element (47),
wherein the first joint element (39) is received in the second joint element (47) and supported in the second joint element (47) in such a manner
that the first joint element (39) in relation to the second joint element (47) is pivotable about a fulcrum (51) which is stationary in terms of the second joint element (47) and coincides with the center of the envelope, and
that the center of the envelope is non-displaceable relative to the second joint element (47),
wherein provided on one of the first and the second joint elements (39, 47) are at least two grooves (45) that run in an arcuate manner, are open toward the envelope and extend along the envelope, and provided on the other one of the first and the second joint elements (39, 47) are at least one first engagement part (57) and one second engagement part (57), wherein the first engagement part (57) extends into the first one of the grooves (45), and the second engagement part (57) extends into the second one of the grooves (45),
wherein the first joint element (39) is attached to one of the base (5) and the proximal end (13) of the control handle (7), and the second joint element (47) is attached to the other one of the base (5) and the proximal end (13) of the control handle (7).

2. The floor cleaning machine of claim 1, wherein the grooves (45) in terms of the center of the envelope are disposed so as to be diametrically opposite on one of the first and the second joint elements (39, 47).

3. The floor cleaning machine of claim 1, wherein the first and the second engagement part (57) are disposed so as to be diametrically opposite in a central plane that runs through the center of the envelope and perpendicularly to the longitudinal axis (11) of the control handle (7).

4. The floor cleaning machine of claim 1, wherein the grooves (45) extend about the envelope by more than 150°.

5. The floor cleaning machine of claim 1, wherein the second articulated joint (47) has a circular receptacle opening (55) having a diameter that is smaller than the diameter of the envelope.

6. The floor cleaning machine of claim 1, wherein at least one of the first engagement part and the second engagement part is configured as a ball (57) which is mounted so as to be stationary and rotatable on the other one of the first and the second joint elements (47), and able to roll in one of the grooves (45).

7. The floor cleaning machine of claim 1, wherein the two grooves (45) that run in an arcuate manner are provided on the first joint element (39), and the first engagement part and the second engagement part (57) are provided on the second joint element (47).

8. The floor cleaning machine of claim 1, wherein the first joint element (39) is attached to the base (5), and the second joint element (47) is attached to the proximal end (13) of the control handle (7).

9. The floor cleaning machine of claim 1, wherein the joint (9) has a locking assembly that is movable between a releasing position and a locking position,
wherein the second joint element (47) is pivotable about the first joint element (39) when the lock assembly is in the releasing position, and
wherein the second joint element (47) is not pivotable about the first joint element (39) when the lock assembly is in the locking position.

10. The floor cleaning machine of claim 9, wherein one of the first and the second joint elements (39, 47) has a receptacle clearance (61) of which the opening extends toward the envelope,
wherein on the other one of the first and the second joint elements (39, 47) is provided a latch element (59) which, in a direction that runs perpendicularly to the envelope, is displaceable in relation to the other one of the first and the second joint elements (39, 47) such that said latch element does not extend beyond the envelope toward the one of the first and the second joint elements (39, 47) when the locking assembly is in the releasing position, and said latch element extends beyond the envelope toward the one of the first and the second joint elements (39, 47), and into the receptacle clearance when the locking assembly is in the locking position.

11. The floor cleaning machine of claim 10, wherein the receptacle clearance (61) is provided on the first joint element (39), and the latch element (49) is provided on the second joint element (47).

12. The floor cleaning machine of claim 1, wherein the at least one engagement element (35) has a free end,
wherein the at least one free end defines a cleaning plane in which the at least one engagement element (35) engages with the floor area (3), and
wherein the control handle (7) is pivotable relative to the base (5) to a vertical position in which the longitudinal axis (11) of the control handle (7) extends upward away from the cleaning plane (37).

13. The floor cleaning machine of claim 12, wherein the longitudinal axis (11) of the control handle (7) is perpendicular to the cleaning plane.

14. The floor cleaning machine as claimed of claim 12, wherein the control handle (7) is in the vertical position when the locking assembly is in the locking position.

15. The floor cleaning machine of claim 12, wherein the floor cleaning machine (1) is configured to be moved across the floor area (3) to be cleaned when operated in a cleaning operation, and
wherein a pre-loading element (65, 67) is provided which, in the position in which the control handle (7) is pivoted from the vertical position counter to the main operating direction (63), is designed to impinge said control handle (7) with a force toward the vertical position.

16. The floor cleaning machine of claim 15, wherein the pre-loading element is configured as a spring element (71) that by way of a first end (69) is fastened to the control handle (7), the second end (73) of said spring element (71) being connected to a strap element (75),
wherein the strap element (75) on a side of the joint (9) that points in the main operating direction (63) is guided from the control handle (7) to the base (5), and is fastened to the base (5).
